(19) United States
(12) Patent Application Publication
(10) Pub. No.: US 2015/0227576 A1
(43) Pub. Date: Aug. 13, 2015

(54) CHECKING THE COMPLETENESS AND CORRECTNESS OF TRANSITIONS IN ELECTRONIC DATA PROCESSING

(71) Applicant: Klaus Plate, Wiesloch (DE)

(72) Inventor: Klaus Plate, Wiesloch (DE)

(21) Appl. No.: 14/176,636

(22) Filed: Feb. 10, 2014

(51) Int. Cl. G06F 17/30

(52) U.S. Cl. CPC G06F 17/30371; G06F 17/30218

(57) ABSTRACT

Computer-implemented methods, computer-readable media, and computer systems for processing data are described. In a transition from a first stage to a second stage, second stage data records are generated using first stage data records as input. The generating occurs in one or more control sets, each control set associated with processing a batch of the first stage data records without modifying the first stage data records. The generating includes, for each control set, generating second stage values in the second stage data records using first stage values in the first stage data records. The generating further includes generating consistency information for the control set for detecting completeness/correctness of the second stage data records relative to the first stage data records. The consistency information includes information identifying first stage data records used to create associated second stage data records. The second stage data records and the consistency information are stored.

### TECHNICAL FIELD

The present disclosure relates to computer-implemented methods and systems for processing information.

### BACKGROUND

Electronic processing of transactions, such as business-related transactions, can involve thousands or millions of records. Several steps can be involved, for example, to create customer bills from customer transactions that occur during a given time period. Some data may be incorrect, such as through an unauthorized change. Some data may not be processed, such as through an error in processing caused by a scheduling error or a technical problem. Data may be stored in different tables and different systems, and determining the cause or source of incomplete or incorrect data can be challenging and time-consuming.

### SUMMARY

The disclosure generally describes computer-implemented methods, computer-readable media, and computer systems for providing instructions for checking the completeness and correctness of transitions in electronic data processing. As an example, in a transition from a first stage to a second stage, second stage data records are generated using first stage data records as input. The generating occurs in one or more control sets, each control set associated with processing a batch of the first stage data records. The generating occurs without modifying the first stage data records other than fields associated with a processing status of the first stage data records. The generating includes, for each control set, generating second stage values in the second stage data records using first stage values in the first stage data records. The generating further includes, for each control set, generating consistency information for the control set for use in detecting completeness and correctness of the second stage data records relative to the first stage data records. The consistency information includes information that identifies which first stage data records were used to create associated second stage data records. The second stage data records and the consistency information are stored in association with the transition.

The present disclosure relates to computer-implemented methods, computer-readable media, and computer systems for providing and executing queries. One computer-implemented method includes: in a transition from a first stage to a second stage, second stage data records are generated using first stage data records as input, the generating occurring in one or more control sets, each control set associated with processing a batch of the first stage data records, wherein the generating occurs without modifying the first stage data records other than fields associated with a processing status of the first stage data records, and wherein the generating includes, for each control set: generating second stage values in the second stage data records using first stage values in the first stage data records; and generating consistency information for the control set for use in detecting completeness and correctness of the second stage data records relative to the first stage data records, wherein the consistency information includes information that identifies which first stage data records were used to create associated second stage data records; and storing the second stage data records and the consistency information in association with the transition.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect, combinable with any of the previous aspects, generating the consistency information and storing the consistency information for the control set includes: computing a unique control set identifier associated with data records processed in the transition, the unique control set identifier for use in matching second stage data records in the control set with associated first stage data records in the control set; storing the unique control set identifier as a sending control set identifier stored with the each of the first stage data records; storing the unique control set identifier as a receiving control set identifier stored with each of the second stage data records; and for each particular second stage data record, computing a record counter that identifies a the number of first stage data records used to generate the particular second stage data record, and storing the record counter with the particular second stage data record.

In a second aspect, combinable with any of the previous aspects, the method further includes: in response to determining that the transition has occurred, determining a correctness of the transition; and providing information associated with determination of correctness.

In a third aspect, combinable with any of the previous aspects, determining the correctness of the transition comprises determining the correctness of the transition with regards to the record counter associated with the second stage, including comparing the record counter associated with the second stage with the number of associated source records from the first stage; and providing information associated with the correctness of the transition.

In a fourth aspect, combinable with any of the previous aspects, determining the correctness of the transition comprises determining the correctness of the transition with regards to second stage amounts, including comparing the second stage amounts to a sum of the first stage amounts of associated first stage data records; and providing information associated with the correctness of the transition.

In a fifth aspect, combinable with any of the previous aspects, the fields associated with the processing status of the first stage data records include status fields that assign a control set identifier and indicate that the first stage data records have been processed.

In a sixth aspect, combinable with any of the previous aspects, the method further includes generating, in a subsequent transition from the second stage to a third stage, third stage data records using second stage data records as input, the generating occurring in one or more subsequent control sets, each subsequent control set associated with processing a batch of second stage data records, wherein the generating occurs without modifying the second stage data values other than fields associated with a processing status of the first stage data records, and wherein the generating includes, for each subsequent control set: generating third stage values in the third stage data records using second stage values in the second stage data records; and generating consistency information for the subsequent control set for use in detecting completeness and correctness of the third stage data records relative to the second stage data records, the consistency information including sending control set identifiers stored with the each of the second stage data records and matching receiving control set identifiers stored with the each of the third stage data records derived from the associated second stage data records; and storing the third stage data records and the consistency information in association with the subsequent transition.

In a seventh aspect, combinable with any of the previous aspects, the method further includes performing a secondary operation that occurs between stages.

In an eighth aspect, combinable with any of the previous aspects, the method further includes each data record of the first stage data records and the second stage data records includes at least one of: one or more stable attributes, wherein each stable attribute comprises a value that remains substantially unchanged in the transition and is used to match up associated data records; and one or more stable amounts, wherein each stable amount comprises a value that is operated upon.

In a ninth aspect, combinable with any of the previous aspects, the method further includes operations used in generating the second stage values including to include one or more of addition, subtraction, multiplication, division, concatenation, Boolean, set, and/or other math and string operations.

In a tenth aspect, combinable with any of the previous aspects, the second stage data records are optionally stored in one or more different locations as the first data records.

In an eleventh aspect, combinable with any of the previous aspects, particular ones of the data records are stored in one or more different data tables and optionally distributed at different locations.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example environment for checking the completeness and correctness of transitions during electronic processing of data.

FIG. 2 shows example transitions associated with generating data within stages.

FIG. 3 shows a flowchart of an example method for generating second stage data records from first stage data records.

### DETAILED DESCRIPTION

This disclosure generally describes computer-implemented methods, computer-readable media, and computer systems for updating business-related information. The following description is presented to enable any person skilled in the art to practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Business-related information can be updated in stages, e.g., with pre-defined transitions between stages. For example, a first transition can create data records in a second stage using first stage data records. A transition in this context can include the creation of new database records based on the processing of existing database records. The old and the new records may be stored in different tables and/or different systems. In some implementations, each data record of the first stage data records and the second stage data records includes at least one of attributes and/or amounts. For example, data records can include one or more stable attributes, wherein each stable attribute comprises a value (e.g., a customer identifier or account number) that remains substantially unchanged in the transition and is used to match up associated data records. Data records can also include one or more stable amounts, wherein each stable amount comprises a value (e.g., a dollar amount) that is operated upon (e.g., aggregated).

Transitions can include, for example, operations that are performed on attributes in the data records. For example, operations can include one or more of addition, subtraction, multiplication, division, concatenation or other string operations, Boolean operations, and set operations. Other operations and combinations of operations are possible.

Methods and techniques described herein can be used to ensure the completeness of transitions (e.g., that every record has been processed) and the correctness of selected data (e.g., that data that passes from the source records to target records arrives in the target record unchanged). For example, in the telecommunications industry, there can be multi-step processing starting from an event that is to be priced (e.g., a phone call or a message) and ending with a monthly invoice for the customer. In this case, database records may be processed in the following stages: 1) a charged item, including determining a price and customer number, is created for the event; 2) based on the charged item, a billable item is created in the billing system; 3) billable items are aggregated into billing document items for further processing in the billing system; 4) billing document items are aggregated into customer invoices once a month; and 5) customer invoices lead to a posting in a receivables accounting system to do the collections.

In this example and in other scenarios, revenue assurance and fraud detection can benefit from methods that ensure that no data is lost in this processing chain, and that none of the most relevant data (e.g., in this scenario, the customer number and amount) are manipulated during processing the records or later on, e.g., when the records are stored in their respective database tables. As such, a transition can include a process that creates one or more new database records (e.g., target records) based on one or more existing database records (source records) where the existing records and the new records may be stored in different database tables and different systems. Source records are typically not to be deleted, but their status can be changed to “processed.” In some instances, the status of a particular source record may not be literally marked “processed,” but rather certain fields may be filled or completed to indicate that the particular source record has actually been processed. Transactions that occur in this way, and that are discussed in this disclosure, are considered to be accumulating transitions.

For example, an accumulating transition is a transition in which every target record is generated using one or more source records, and no source record can lead to more than one target record. A stable attribute within a transition is defined to be an attribute that typically has the same value for all source records and any target records for which they are processed (e.g., passed into). Example stable attributes include customer names, account numbers, and/or other typically non-quantitative identifying information.

A stable amount set for a transition T can be defined to be a set of amount fields {TA, SA₁, . . . , SA. }, in which TA is an amount in the target record, SA₁ are amounts in the source records and a calculation function F so that:

value(TA)=F(sum(SA₁), . . . , sum(SAₙ), other parameters of the target record) (1)

holds for all target records within the target set. The sums can be taken over all the source records passed into the particular target record.

A control set is defined to be a subset of the source records which are processed by the transition process. A control set can be a unit for which the completeness and correctness of the transition can be verified. A control set can be represented by a unique key, such as a control set identifier. A transtion can occur, in the example above, when records of stage 1 are processed to create records of stage 2. More generally, transition n (e.g., Tₙ) occurs when records of stage n are processed to create records of stage n+1.

In some implementations, controls sets, including the number of data records to be processed in the control set, can be chosen in different ways. For example, control sets can be sized based on a predefined set or a predefined number of records, or based on a group of records that have timestamps in a certain range. In another example, control sets can be sized or based on a number of records for which for a reasonable identification, review and correction of a detected error can occur based on the number of records processed. Other ways of selecting control sets can be used.

Accumulating transitions are given in the example above in stages 2, 3 and 4 of the telecommunications example. In stage 2, for example, every target record is based on exactly one source record with the same amount. In stages 3 and 4, for example, target records are built based on one or more source records by summing up records with similar attributes (e.g., all national phone calls of one customer within a given period).

Stable attributes in the example above can include, for example, the customer number or the contract number assigned to the records. Note that different transitions Tₙ and Tₙ₊₁ may have different stable attributes (e.g. customer number and contract number for Tₙ but only customer number for Tₙ₊₁).

A stable amount set, for example, can exist when simply summing up a particular amount field for the transition Tₙ. In this example, the function F can be the identity function, and the formula reduces to value(TA)=sum(SA₁). For example, if SA₁ contains the amount (e.g., phone charge amount) of a phone call, then TA would contain the amount of all phone calls of one day, e.g., if Tₙ accumulates the calls per day.

In another example that deals with two fields in the source records, SA₁ can be the net amount before discount, and SA₂ can be a discount amount. If TA is the accumulated net amount after discount, then the resulting formula can be:

value(TA)=F(sum(SA₁), sum(SA₂))=sum(SA₁)−sum(SA₂) (2)

In another example that includes taxes, the previous example can be modified in a way such that TA is the gross amount, including a given tax percentage, assuming the tax percentage T % is an attribute in the target record. In this example, the resulting formula can be:

value(TA)=F(sum(SA₁), sum(SA₂), T %)=(sum(SA₁)−sum(SA₂))×(1+T %/100) (3)

A control set may be defined to be the set of all source records which are processed within a given time interval (e.g., which are processed on the same day or in the same hour). Control sets can be pre-defined to include a specific set of data records or a specific number of data records. In some implementations, control sets can be defined in real time, e.g., based on conditions associated with the source data records or for other reasons. Another way would be to define a control set as the set of all records processed by the same job if several jobs, in parallel, process the source records. In some implementations, control sets can be created or selected by any suitable method, e.g., that ensures that every source record belongs to exactly one control set and that source records which need to be processed in a whole belong to the same control set, e.g., all records for a particular customer in a given period in order to create one customer invoice.

The subject matter described in this specification can be implemented in particular implementations so as to realize one or more of the following advantages. Information associated with the completeness and correctness of processed data records can be generated, stored, and if needed, used to identify errors, achieve revenue assurance, and perform fraud detection in a systematic approach.

In some implementations, additional values can exist that may not be relevant for a transition from one stage to another. For example, values such as taxation flags or other values, can be set in one stage and used in one or more other stages that follow the immediately subsequent stage. The values can be created, for example, based on a manipulation of a stable value (e.g., taxes or discounts). Those new numbers can then be used as a stable value in the next transition, e.g., the set of stable values may change between different stages.

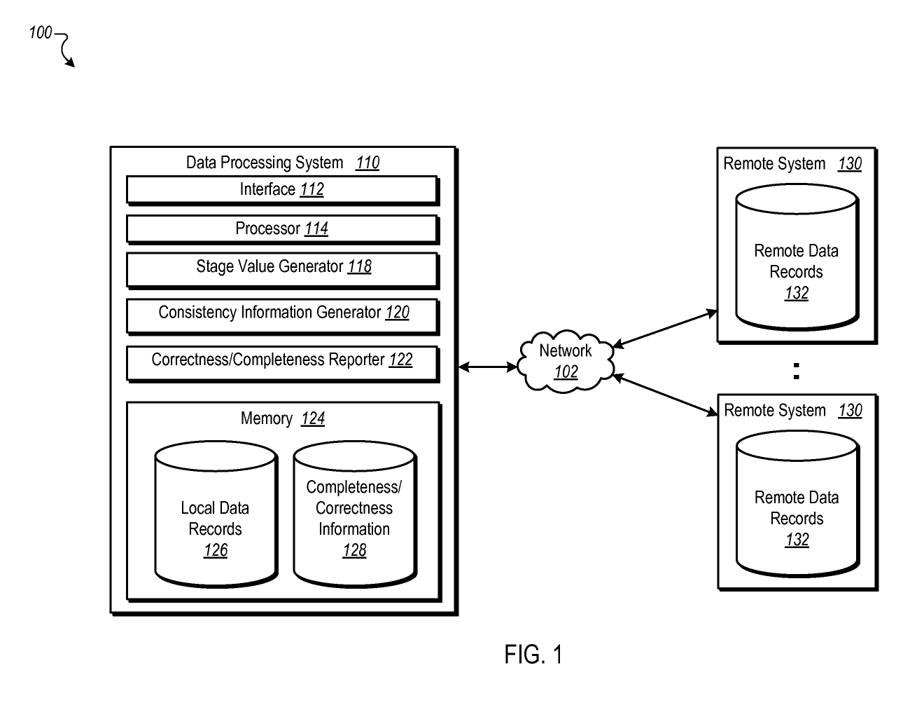

FIG. 1 illustrates an example environment 100 for checking the completeness and correctness of transitions during electronic processing of data. Specifically, the illustrated environment 100 includes at least one data processing system 110, including local data records 126, and any number of remote systems 130, each having remote data records 132. The data processing system 110 and the remote system(s) 130 are communicably coupled using a network 102. The data processing system 110, for example, can process data in one or more transitions from one stage to another using the local data records 126 and the remote data records 132.

Although FIG. 1 illustrates a single data processing system 110, the environment 100 can be implemented using two or more data processing systems 110, each capable of generating data records for one stage using a previous stage, and checking the completeness and correctness of transitions in electronic data processing. The environment 100 can also be implemented using computers, servers, or other components. Indeed, components of the environment 100 may be any computer or processing device. According to some implementations, components of the environment 100 may also include, or be communicably coupled with, an e-mail server, a web server, a caching server, a streaming data server, and/or other suitable server(s). In some implementations, components of the environment 100 may be distributed in different locations and coupled using the network 102.

The data processing system 110 includes an interface 112, a processor 114, a stage value generator 118, a consistency information generator 120, a memory 124, and other elements as described below. The interface 112 can be used by the data processing system 110 for communicating with remote systems 130 in a distributed environment, connected to the network 102, as well as other systems (not illustrated) communicably coupled to the network 102. Generally, the interface 112 comprises logic encoded in software and/or hardware in a suitable combination and operable to communicate with the network 102. More specifically, the interface 112 may comprise software supporting one or more communication protocols associated with communications such that the network 102 or interface's hardware is operable to communicate physical signals within and outside of the illustrated environment 100.

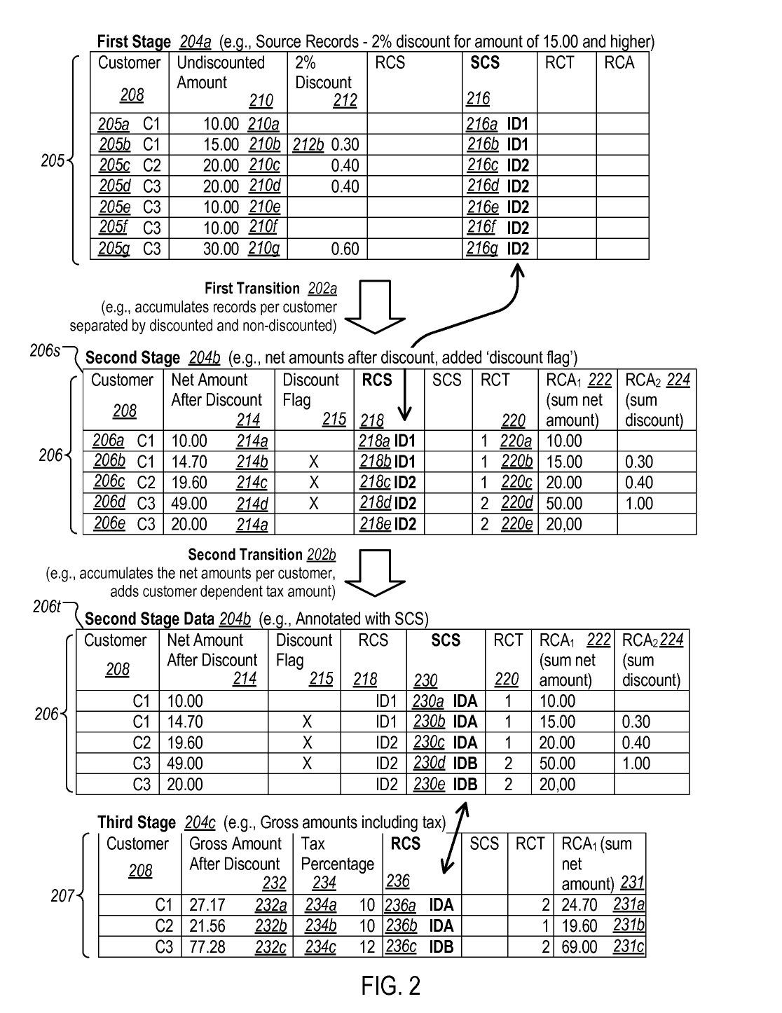

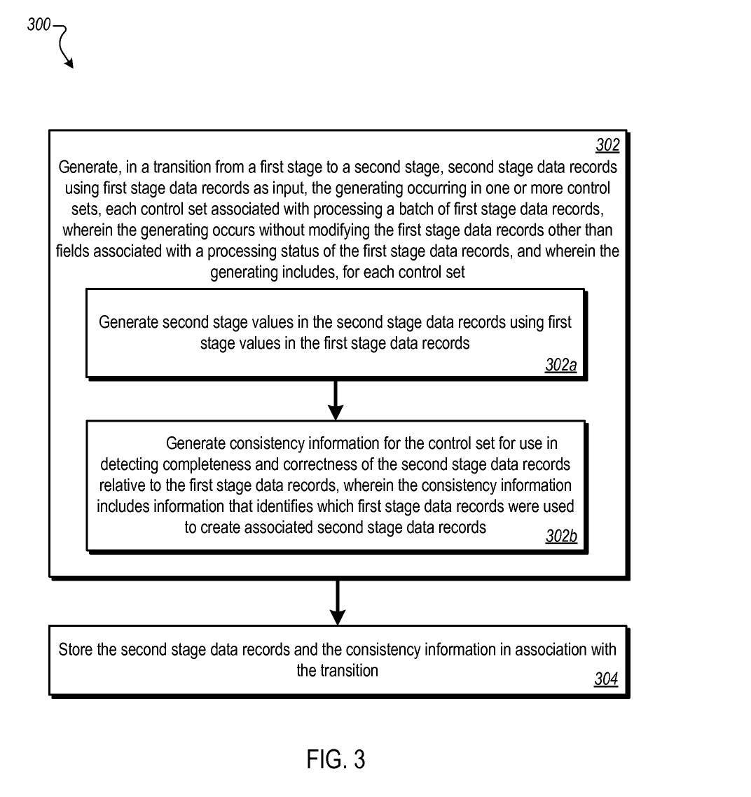

The stage value generator 118 (or sub-components therein) can generate second stage data records using first stage data records. For example, in one or more transitions, the stage value generator 118 can generate billing-related records from transaction-related records, such as related to customer calls and accounts in a telecommunications system. More detailed examples of operations performed by the stage value generator 118 are provided below with reference to FIGS. 2 and 3.

The consistency information generator 120 can generate information that is used to maintain and check the completeness and correctness of data records, e.g., related to transitions. For example, the information generated can identify specific data records in the local data records 126 and the remote data records 132 that are used to make other records in the local data records 126 and the remote data records 132. In some implementations, the consistency information generator 120 can manage the determination and assignment of control sets. More detailed examples of operations performed by the consistency information generator 120 are provided below with reference to FIGS. 2 and 3.

The processor 114 can be used by the stage value generator 118 and the consistency information generator 120 when generating data records within the environment 100, e.g., using other data records in the environment 100. For example, for any one transition, the processor 114 can use combinations of the local data records 126 and the remote data records 132 to create new records, e.g., in a transition from one stage to another. Although illustrated as the single processor 114 in FIG. 1, two or more processors 114 may be used according to particular needs, desires, or particular implementations of the environment 100. Generally, the processor 114 executes instructions and manipulates data to perform the operations of the stage value generator 118, the consistency information generator 120, and other components of the data processing system 110.

The data processing system 110 also includes the memory 124. Although illustrated as a single memory 124 in FIG. 1, two or more memories 124 may be used according to particular needs, desires, or particular implementations of the environment 100. While memory 124 is illustrated as an integral component of the data processing system 110, in alternative implementations, memory 124 can be external to the data processing system 110 and/or the environment 100. In some implementations, memory 124 includes the local data records 126, which can include stage-related data for one or more stages. Memory 124 also includes the completeness/correctness information 128. Other components within the memory 124 are possible.

In some implementations, the data processing system 110 can also include a correctness/completeness reporter 122. For example, the correctness/completeness reporter 122 can determine, using the completeness/correctness information 128, whether data records associated with a particular transition and associated stages are complete and/or correct. Examples types of reporting that can be provided by the correctness/completeness reporter 122 are described in detail below with reference to FIG. 3.

FIG. 2 shows example transitions 202a and 202b associated with generating data within stages 204a, 204b, and 204c. For example, a first transition 202a can be associated with creating second stage data records 206 of a second stage 204b using first stage data records 205 of a first stage 204a. In this example, the first stage data records 205 are source records for the first transition 202a, e.g., in which a 2% discount 212 has been identified for undiscounted amounts 210a-210g of $15 or more for customers 208 (e.g., telecommunications customers). As an example, the undiscounted amount 210b (e.g., $15.00) warrants the 2% discount 212b (e.g., 30 cents). FIG. 2 includes correctness/completeness-related fields, e.g., including fields for a receiving control set (RCS) identifier, a sending control set (SCS) identifier, a record counter (RCT) for a number of associated source records, and a receiving amount (RCA) for the stable amounts.

The first transition 202a, for example, can be a transition from the first stage 204a to the second stage 204b, in which second stage data records 206 are generated using first stage data records 205 as input. The first transition 202a, for example, can accumulate records on a per customer 208 basis and segregated by discounted and non-discounted record amounts. In some implementations, the generating can occur in one or more control sets, e.g., in which each control set is associated with processing a batch (e.g., a subset) of the first stage data records 205. In this example, generating second stage data records 206 can occur without modifying the first stage data records 205 (with the exception of the field SCS, i.e., the sending control set identifier). For example, static amounts are left unchanged, e.g., including identifiers for customers 208, undiscounted amounts 210, and discounts 212. In some implementations, generating the second stage data records 206 can include generating, for each control set, second stage values and consistency information, described in detail below. For the first transition 202a,and for any other transtions, control sets can be identified at runtime, e.g., when the transition and operations are executed. Information associated with the control set can be used in fields added to the original records. By adding fields, for example, the essence of the data values (e.g., amounts, etc.) is not changed, but the additional fields added for consistency calculations can be modified as needed.

Generating second stage values in the second stage data records 206, for example, can use first stage values in the first stage data records 205. For example, net amounts 214 can be calculated as accumulated differences, on a per customer 208 basis, of undiscounted amounts 210 minus any associated discounts 212. In this example, first stage data records 205a-205b that have the same customer 208 (e.g., “C1”) are accumulated into second stage data records 206a-206b, accumulating records per customer and separated by discounted and non-discounted amounts. First stage data record 205c, being the only first stage data record 205 for the customer 208 of “C2,” is accumulated into a second stage data record 206c. Also, for customer 208 “C3”, discounted first stage data records 205d and 205g are accumulated into a single discounted second stage data record 206d, and nondiscounted first stage data records 205e and 205f are accumulated into a single discounted second stage data record 206e.

In the first transition 202a, for example, the processing can occur using two control sets, such as identified by control set identifiers ID1 and ID2, respectively. For example, data records associated with customer C1 can be processed in the control set identified by control set identifier ID1, and data records associated with customers C2 and C3 can be processed in the control set identified by control set identifier ID2. The control set identifiers ID1 and ID2, for example, can be part of consistency information that is generated and stored for the control sets for use in detecting completeness and correctness of the second stage data records relative to the first stage data records. For example, the consistency information can include information (e.g., control set identifiers ID1 and ID2) that identifies which first stage data records 205 were used to create associated second stage data records 206. The control set identifier ID1, for example, can be stored as sending control set identifiers 216a-216b for customer C1 records in the first stage data records 205, and stored as receiving control set identifiers 218a-218b for customer C1 records in the second stage data records 206. Also, the control set identifier ID2 can be stored as sending control set identifiers 216c-216g for customer C2 records in the first stage data records 206, and stored as receiving control set identifiers 218c-218e for customer C2 records in the second stage data records 206. In this way, the control set identifiers ID1 and ID2 can serve to point both directions to cross-reference source and target records for stages 204a and 204b, respectively.

In some implementations, consistency information that is generated and stored for the control sets can also include record counts. For example, record counts 220 can identify, for each second stage data record 206, the number of first stage data records 205 that were processed to generate associated second stage data records 206. The sum of the record counts 220a-220e, e.g., 1, 1, 1, 2 and 2, respectively, can equal the total count of the first stage data records 205, e.g., 7.

Additional processing in the first transition 202a, for example, can include the generation of receiving amounts 222 and discount amounts 224. For example, the receiving amount 222 can be an accumulation of undiscounted amounts 210 and discounts 212, respectively, from the corresponding first stage data records 205. For example, discount flags 215 can be set to “X” whenever a non-zero discount amount appears in the corresponding discount amount 224.

In some implementations, the first transition 202a can be considered complete when all first stage data records 205 are processed. This can be indicated, for example, when all first stage data records 205 have a non-null value for the sending control set identifier 216. In some implementations, the explicit “processed” fields can be used instead of, or in addition to, checking whether fields are null or not.

In some implementations, although the first stage data records 205 and second stage data records 206 are each represented by tables in FIG. 2, the data can be stored in different places. For example, the data can exist in multiple RDBMS tables and joined using table joins. Data can also exist, for example, in other file formats. In some implementations, some or all of the data can exist in an in-memory database or databases, e.g., as combinations and/or joins of data from other sources. In some implementations, data can also be distributed, e.g., with one or more rows or columns begin stored in any of multiple different locations.

Transitions can also exist that are associated with other stages. For example, subsequent to completion of the first transition 202a, the second transition 202b can be a transition, between the second stage 204b and the third stage 204c, that accumulates net amounts on a per-customer basis and adds customer dependent tax amounts. The second transition 202b, for example, can generate third stage data records 207 using second stage data records 206 as input. The generating can occur using one or more subsequent control sets, e.g., control sets having control set identifiers IDA and IDB respectively. The IDA control set, for example, can be used for processing second stage data records 206 associated with customers C1 and C2. The IDB control set, for example, can be used for processing second stage data records 206 associated with customer C3. In this example, third stage data records 207 can be created without modifying data values in the second stage data records 206, such as customers 208, net amounts 214, discount flags 215, receiving control set identifiers 218, receiving amounts 222, and discount amounts 224.

To help illustrate the processing that occurs during the second transition 202b, table 206t lists values for the second stage data records 206 that are also shown in table 206s, as generated by the first transition 202a. As will be shown in examples, table 206t will also be used to identify values that are generated during the second transition 202b, including storing consistency information for use in detecting completeness and correctness of the third stage data records 207 relative to the second stage data records 206.

During the second transition 202b, for example, third stage values can be generated in the third stage data records 207 using second stage values in the second stage data records 206. For example, the stage value generator 118 can generate after-discount gross amounts 232 using accumulated differences 231 of receiving amounts 222 minus discount amounts 224. Also added to the after-discount gross amounts 232 are tax amounts computed as a product of a tax percentage 234 and the accumulated difference 231.

Consistency information for the second transition 202b can be generated for the subsequent control sets for use in detecting completeness and correctness of the third stage data records 207 relative to the second stage data records 206. The consistency information can include sending control set identifiers (e.g., IDA and IDB) that are stored as sending control set identifiers 230 in the second stage data records 206 and corresponding receiving control set identifiers 236 in the third stage data records 207. For example, the sending control set identifier IDA can be stored for customer C1 and C2 records as sending control set identifiers 230a-230c and receiving control set identifiers 236a-236b. Also, the sending control set identifier IDB can be stored for customer C3 records as sending control set identifiers 230d-230e and receiving control set identifier 236c. In this way, second stage 204b records and corresponding third stage 204c records are cross-referenced.

FIG. 3 shows a flowchart of an example method 300 for generating second stage data records from first stage data records. For clarity of presentation, the description that follows generally describes method 300 in the context of FIGS. 1 through 2. However, it will be understood that the method 300 may be performed, for example, by any other suitable system, environment, software, and hardware, or a combination of systems, environments, software, and hardware as appropriate.

At 302, in a transition from a first stage to a second stage, second stage data records are generated using first stage data records as input, the generating occurring in one or more control sets, each control set associated with processing a batch of first stage data records, wherein the generating occurs without modifying the first stage data records other than fields associated with a processing status of the first stage data records, and wherein the generating includes, for each control set. For example, as described above with respect to FIG. 2, the stage value generator 118 can generate, in the first transition 202a, the second stage data records 206 using the first stage data records 205. In some implementations, the fields associated with the processing status of the first stage data records can include status fields that assign a control set identifier and indicate that the first stage data records have been processed.

At 302a, second stage values are generated in the second stage data records using first stage values in the first stage data records. As an example, the stage value generator 118 can generate the net amounts 214 using undiscounted amounts 210 and, when applicable, 2% discounts 212. For the first of two control sets used in the first transition 202a, the first stage data records 105 that are processed can include the records associated with customer C1. For the second of two control sets used in the first transition 202a, the first stage data records 105 that are processed can include the records associated with customers C2 and C3.

At 302b, consistency information is generated for the control set for use in detecting completeness and correctness of the second stage data records relative to the first stage data records, wherein the consistency information includes information that identifies which first stage data records were used to create associated second stage data records. For example, the consistency information generator 120 can use the control set identifiers ID1 and ID2 for the first and second control sets, respectively, as described above.

In some implementations, generating the consistency information and storing the consistency information for the control set can include computing a unique control set identifier associated with data records processed in the transition, the unique control set identifier for use in matching second stage data records in the control set with associated first stage data records in the control set, storing the unique control set identifier as a sending control set identifier stored with the each of the first stage data records, storing the unique control set identifier as a receiving control set identifier stored with each of the second stage data records, and for each particular second stage data record, computing a record counter that identifies a number of first stage data records used to generate the particular second stage data record, and storing the record counter with the particular second stage data record. For example, for the first control set used for the first transition 202a, the consistency information generator 120 can generate the control set identifier ID1 for storage in the first stage data records 205a-205b and also in the second stage data records 206a-206b associated with customer C1. The consistency information generator 120 can store the record counts 220a-220b that identify the number of first stage data records 205 processed for each respective second stage data record 206. Other types of consistency information are possible.

At 304, the second stage data records and the consistency information are stored in association with the transition. As an example, the consistency information generator 120 can store the values and control set identifiers ID1 and ID2 in the second stage data records 206, and the control set identifiers ID1 and ID2 in corresponding ones of the first stage data records 205.

In some implementations, the second stage data records can be optionally stored in one or more different locations as the first stage data records. For example, the first stage data records 105 can be stored in some combination of local data records 126 and one or more of the remote data records 132, and the second stage data records 106 can be stored in some combination different ones of the local data records 126 and one or more of the remote data records 132.

In some implementations, particular ones of the data records can be stored in one or more different data tables and optionally distributed at different locations. As an example, any or all of the first stage data records 105 and the second stage data records 106 can be stored in different locations, e.g., and combined or joined in some way to logically create the data base records.

In some implementations, method 300 can further comprise, in response to determining that the transition has occurred, determining a correctness of the transition, and providing information associated with the determined correctness. For example, at a time at which it is thought that the first transition 202a is complete, and/or at other times, the correctness/completeness reporter 122 can perform one or more different types of analysis, each identifying whether data records associated with the transition are complete and correct.

In some implementations, determining the correctness of the transition can comprise determining the correctness of the transition with regards to the record counter associated with the second stage, including comparing the record counter associated with the second stage with a sum of associated source records from the first stage, and providing information associated with the correctness of the transition. For example, a correctness of a transition T. (e.g., the first transition 202a) for a control set with a sending control set (SCS) identifier of X and corresponding receiving control set (RCS) with regard to the number of records (e.g., first stage data records 205 and second stage data records 206) can compare, for record counter RCT:

count(source records(SCS=X))=sum(RCT/target records(RCS=X)) (4)

In some implementations, determining the correctness of the transition can comprise determining the correctness of the transition with regards to second stage amounts, including comparing the second stage amounts to a sum of the first stage amounts of associated first stage data records, and providing information associated with the correctness of the transition. For example, a correctness of a transition T. (e.g., the first transition 202a from the first stage 204a to the second stage 204b) for a control set with a sending control set (SCS) identifier of X and corresponding receiving control set (RCS) with regard to RCA amounts can compare:

sum(amount; source records(SCS=X))=sum(RCA; target records(RCS=X)) (5)

If, for example, there are multiple Amount fields RCAᵢ, then this condition can be checked for all of them:

sum(amountᵢ/source records(SCS=X))=sum(RCAᵢ/target records(RCS=X)) (6)

In some implementations, determining the correctness of the transition can comprise determining the correctness of the transition with regards to stable amounts, including comparing stable amounts in the second stage data records with the corresponding stable amounts in the first stage data records, and providing information associated with the correctness of the transition. For example, a correctness of a transition Tₙ for a control set with a sending control set (SCS) identifier of X and corresponding receiving control set (RCS) with regard to stable amount sets can compare:

value(TA)=F(RCA₁, . . . , RCAₙ, . . . ) (7)

In some implementations, other ways of determining the correctness and completeness are possible. For example, the correctness/completeness reporter 122 can perform one or more other different types of analysis to determine if all first stage data records are processed and/or if dates related to the processing are appropriate.

In some implementations, the method 300 can further comprise generating third stage data records. For example, referring to FIG. 2, in a subsequent transition from the second stage 204b to the third stage 204c, third stage data records 207 can be generated using second stage data records 206 as input. The generating can occur using one or more subsequent control sets (e.g., IDA and IDB). Each subsequent control set can be associated with processing a batch of second stage data records, and the generating can occur without modifying the second stage data values, as described above. The generating can include, for each subsequent control set, generating third stage values in the third stage data records 207 using second stage values in the second stage data records 206. The generating can include, for each subsequent control set, generating consistency information for the subsequent control set for use in detecting completeness and correctness of the third stage data records relative to the second stage data records. The consistency information can include, for example, generating control set identifiers (e.g., IDA and IDB) stored with the each of the second stage data records 207 and matching receiving control set identifiers stored with the each of the third stage data records 207 derived from the associated second stage data records 206. The third stage data records 207 and the consistency information can be stored in association with the subsequent second transition 202b.

In some implementations, the method 300 can further comprise performing a secondary operation that occurs between stages. For example, the data processing system 110 or one or more of the remote systems 130 can perform processing that updates a data record, e.g., adding one or more values (e.g., columns) to the data records (e.g., tables 206s or 206t). Other secondary operations are possible.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, example environment 100 may use processes with additional, fewer and/or different operations, as long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any implementation or on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

What is claimed is:

1. A computer-implemented method for processing data records, comprising:
generating, in a transition from a first stage to a second stage, second stage data records using first stage data records as input, the generating occurring in one or more control sets, each control set associated with processing a batch of the first stage data records, wherein the generating occurs without modifying the first stage data records other than fields associated with a processing status of the first stage data records, and wherein the generating includes, for each control set:
generating second stage values in the second stage data records using first stage values in the first stage data records; and
generating consistency information for the control set for use in detecting completeness and correctness of the second stage data records relative to the first stage data records, wherein the consistency information includes information that identifies which first stage data records were used to create associated second stage data records; and
storing the second stage data records and the consistency information in association with the transition.

2. The method of claim 1, wherein generating the consistency information and storing the consistency information for the control set includes:
computing a unique control set identifier associated with data records processed in the transition, the unique control set identifier for use in matching second stage data records in the control set with associated first stage data records in the control set;
storing the unique control set identifier as a sending control set identifier stored with the each of the first stage data records;
storing the unique control set identifier as a receiving control set identifier stored with each of the second stage data records; and
for each particular second stage data record, computing a record counter that identifies the number of first stage data records used to generate the particular second stage data record, and storing the record counter with the particular second stage data record.

3. The method of claim 2, further comprising:
in response to determining that the transition has occurred, determining a correctness of the transition; and
providing information associated with determination of correctness.

4. The method of claim 3 wherein determining the correctness of the transition comprises determining the correctness of the transition with regards to the record counter associated with the second stage, including comparing the record counter associated with the second stage with a sum of associated source records from the first stage; and
providing information associated with the correctness of the transition.

5. The method of claim 3 wherein determining the correctness of the transition comprises determining the correctness of the transition with regards to second stage amounts, including comparing the second stage amounts to a sum of the first stage amounts of associated first stage data records; and
providing information associated with the correctness of the transition.

6. The method of claim 1 wherein the fields associated with the processing status of the first stage data records include status fields that assign a control set identifier and indicate that the first stage data records have been processed.

7. The method of claim 1, further comprising:
generating, in a subsequent transition from the second stage to a third stage, third stage data records using second stage data records as input, the generating occurring in one or more subsequent control sets, each subsequent control set associated with processing a batch of second stage data records, wherein the generating occurs without modifying the second stage data values other than fields associated with a processing status of the second stage data records, and wherein the generating includes, for each subsequent control set:
generating third stage values in the third stage data records using second stage values in the second stage data records; and
generating consistency information for the subsequent control set for use in detecting completeness and correctness of the third stage data records relative to the second stage data records, the consistency information including sending control set identifiers stored with the each of the second stage data records and matching receiving control set identifiers stored with the each of the third stage data records derived from the associated second stage data records; and
storing the third stage data records and the consistency information in association with the subsequent transition.

8. The method of claim 1, further comprising performing a secondary operation that occurs between stages.

9. The method of claim 1, wherein each data record of the first stage data records and the second stage data records includes at least one of:
one or more stable attributes, wherein each stable attribute comprises a value that remains substantially unchanged in the transition and is used to match up associated data records; and
one or more stable amounts, wherein each stable amount comprises a value that is operated upon.

10. The method of claim 1, wherein operations used in generating the second stage values including to include one or more of addition, subtraction, multiplication, division, concatenation, Boolean, set, and/or other math and string operations.

11. The method of claim 1, wherein the second stage data records are optionally stored in one or more different locations as the first data records.

12. The method of claim 1 wherein particular ones of the data records are stored in one or more different data tables and optionally distributed at different locations.

13. A computer-readable media, the computer-readable media comprising computer-readable instructions embodied on tangible, non-transitory media, the instructions operable when executed by at least one computer to:
generate, in a transition from a first stage to a second stage, second stage data records using first stage data records as input, the generating occurring in one or more control sets, each control set associated with processing a batch of the first stage data records, wherein the generating occurs without modifying the first stage data records other than fields associated with a processing status of the first stage data records, and wherein the generating includes, for each control set:
generate second stage values in the second stage data records using first stage values in the first stage data records; and
generate consistency information for the control set for use in detecting completeness and correctness of the second stage data records relative to the first stage data records, wherein the consistency information includes information that identifies which first stage data records were used to create associated second stage data records; and
store the second stage data records and the consistency information in association with the transition.

14. The computer-readable media of claim 13, wherein generating the consistency information and storing the consistency information for the control set includes:
computing a unique control set identifier associated with data records processed in the transition, the unique control set identifier for use in matching second stage data records in the control set with associated first stage data records in the control set;
storing the unique control set identifier as a sending control set identifier stored with the each of the first stage data records;
storing the unique control set identifier as a receiving control set identifier stored with each of the second stage data records; and
for each particular second stage data record, computing a record counter that identifies a the number of first stage data records used to generate the particular second stage data record, and storing the record counter with the particular second stage data record.

15. The computer-readable media of claim 13, further comprising instructions to:
in response to determining that the transition has occurred, determine a correctness of the transition; and
provide information associated with determination of correctness.

16. The computer-readable media of claim 13, wherein each data record of the first stage data records and the second stage data records includes at least one of:
one or more stable attributes, wherein each stable attribute comprises a value that remains substantially unchanged in the transition and is used to match up associated data records; and
one or more stable amounts, wherein each stable amount comprises a value that is operated upon.

17. A computer system, comprising:
memory operable to store content, including static and dynamic content; and
at least one hardware processor interoperably coupled to the memory and operable to perform instructions to:
generate, in a transition from a first stage to a second stage, second stage data records using first stage data records as input, the generating occurring in one or more control sets, each control set associated with processing a batch of the first stage data records, wherein the generating occurs without modifying the first stage data records other than fields associated with a processing status of the first stage data records, and wherein the generating includes, for each control set:
generate second stage values in the second stage data records using first stage values in the first stage data records; and
generate consistency information for the control set for use in detecting completeness and correctness of the second stage data records relative to the first stage data records, wherein the consistency information includes information that identifies which first stage data records were used to create associated second stage data records; and
store the second stage data records and the consistency information in association with the transition.

18. The computer system of claim 17, wherein generating the consistency information and storing the consistency information for the control set includes:
computing a unique control set identifier associated with data records processed in the transition, the unique control set identifier for use in matching second stage data records in the control set with associated first stage data records in the control set;
storing the unique control set identifier as a sending control set identifier stored with the each of the first stage data records;
storing the unique control set identifier as a receiving control set identifier stored with each of the second stage data records; and
for each particular second stage data record, computing a record counter that identifies the number of first stage data records used to generate the particular second stage data record, and storing the record counter with the particular second stage data record.

19. The computer system of claim 17, further comprising instructions to:
in response to determining that the transition has occurred, determine a correctness of the transition; and
provide information associated with determination of correctness.

20. The computer system of claim 17, wherein each data record of the first stage data records and the second stage data records includes at least one of:
one or more stable attributes, wherein each stable attribute comprises a value that remains substantially unchanged in the transition and is used to match up associated data records; and
one or more stable amounts, wherein each stable amount comprises a value that is operated upon.
